(19) United States
(12) Patent Application Publication
(10) Pub. No.: US 2015/0217237 A1
(43) Pub. Date: Aug. 6, 2015

(54) METHOD FOR PRODUCING A THERMORESPONSIVE FILTRATION MEMBRANE AND THERMORESPONSIVE FILTRATION MEMBRANE

(71) Applicant: Helmholtz-Zentrum Geesthacht Zentrum für Material- und Küstenforschung GmbH, Geesthacht (DE)

(72) Inventors: Volker Abetz, Luneburg (DE); Juliana Clodt, Hamburg (DE); Sofia Rangou, Hamburg (DE); M. Volkan Filiz, Hamburg (DE)

(73) Assignee: Helmholtz-Zentrum Geesthacht Zentrum für Material- und Küstenforschung GmbH, Geesthacht (DE)

(21) Appl. No.: 14/616,041

(22) Filed: Feb. 6, 2015

Related U.S. Application Data
(63) Continuation of application No. PCT/EP2013/001988, filed on Jul. 5, 2013.

(30) Foreign Application Priority Data
Aug. 9, 2012 (EP) 12179780.7

(51) Int. Cl. B01D 69/02; B01D 71/82; B01D 71/40

(52) U.S. Cl. CPC B01D 69/02; B01D 71/40; B01D 71/82; B01D 2325/02; B01D 2325/00

(57) ABSTRACT

The invention relates to a method for producing a thermoresponsive filtration membrane, particularly a microfiltration membrane or ultra-filtration membrane, and a corresponding thermoresponsive filtration membrane. The method according to the invention comprises the following method steps: a) a filtration membrane is wetted or coated with a dopamine solution, b) the dopamine of the dopamine solution is polymerised in order to produce a polydopamine layer, and c) the polydopamine-coated filtration membrane is immersed into a coating solution with an end-functionalised poly(N-isopropylacrylamide), and the poly(N-isopropylacrylamide) is bound to the polydopamine layer.

### CROSS REFERENCE TO RELATED APPLICATIONS

The present application is a continuation application and claims priority benefit under 35 USC §120 to PCT Patent Application No. PCT/EP2013/001988, filed on Jul. 5, 2013, which PCT application claims priority benefit to European Patent Application No. 12179780.7 filed on Aug. 9, 2012, the entireties of each of which are incorporated by reference herein.

### FIELD

The invention relates to a method for producing a thermoresponsive filtration membrane, particularly a microfiltration membrane or ultra-filtration membrane, and a corresponding thermoresponsive filtration membrane.

### BACKGROUND

For filtration, particularly ultra-filtration, membranes that are used today are predominantly produced according to a so-called phase inversion process. These membranes are based on a polymeric backbone that has a continuous porosity, that is, a porous structure that traverses the membrane. The size of the pores determines the separating properties, that is, the size of the molecules that are retained by the membrane or that can penetrate the pores in the membrane. In addition to polymeric membranes, membranes are used that are based on ceramic, glass or metallic materials.

The polymeric membranes produced by precipitant or non-solvent-induced phase inversion normally have a more-or-less large statistical variance in the distribution of the pore size, see S. Nunes, K.-V. Peinemann (ed.): Membrane Technology in the Chemical Industry, Wiley-VCH, Weinheim 2006, pages 23-32. Such membranes tend toward so-called fouling and do not allow precise separation of a mixture of substances due to the wide range of the pore size distribution. Fouling is understood as rapid blocking of the large pores since a large portion of the liquid passing through the membrane first passes through the large pores. It has thus been attempted for some time to produce isoporous membranes, i.e. membranes with a low variance in the distribution of their pore size.

In German patent no. 10 2006 045 282 by the applicant, a method is disclosed by means of which polymer membranes can be produced with isoporous separation-active surfaces. For this purpose, an amphiphilic block copolymer is dissolved in a casting solution with one or more solvents, spread into a film, and the film is immersed in a precipitation bath.

This method exploits the fact that the polymer blocks of the amphiphilic block copolymer are not miscible with each other. The block copolymers therefore form phases in the casting solution such as a known micel structure with spherical or cylindrical micels. Within a short evaporation time, part of the liquid solvent close to the surface evaporates such that the microphase morphology hardens in a layer of the film close to the surface that has formed due to the self-organization of the polymer blocks of the block copolymers, whereas the block copolymers remain dissolved within the bulk of the casting solution.

By dipping this film in a precipitation bath, the rest of the solvent is displaced, and a known phase inversion process occurs which results in a known sponge-like structure. In some cases, the previously assumed microphase-separated isoporous structure of the layer close to the surface is retained despite being dipped in the precipitation bath. This then transitions directly into the sponge-like structure. Additional descriptions are contained in DE 10 2006 045 282 A1, the entire disclosed content of which is incorporated in the present application.

The resulting integral asymmetric structure arises from a combination of two different thermodynamic processes. The method can be performed for block copolymers with different polymer components that separate in a solvent by means of microphase separation. For example in DE 10 2006 045 282 A1, the integral asymmetric structure of the block copolymer membranes is disclosed with reference to the example of a membrane based on PS-b-P4VP (polystyrene-b-poly-4-vinylpyridine). Similar results have been achieved with the significantly chemically different PS-b-P2VP (polystyrene-b-poly-2-vinylpyridine) and PS-b-PEO (polystyrene-b-polyethylene oxide). The results achieved with PS-b-P2VP are published in A. Jung et al. (2012), “Structure Formation of Integral Asymmetric Composite Membranes of Polystyrene-block-Poly(-vinylpyridine) on a Nonwoven”, Macromol. Mater. Eng, doi: 10.1002/mame.201100359. The results with PS-b-PEO are disclosed in German application No. 10 2012 207 338.8 by the applicant.

These and other polymeric membranes as well as non-polymeric filtration membranes such as those based on ceramics can normally only be used for a single application and are subject to fouling, i.e., the pores are clogged by the deposition of macromolecules or other contaminating contents from the liquids to be filtered.

In the last couple of years, research efforts have been pursued of making filtration membranes switchable, that is, rendering their separating properties dependent upon external, controllable conditions. One option in this regard is the production of thermoresponsive membranes, that is, membranes whose separating properties depend on the temperature. Accordingly, membranes were produced that were modified with poly(N-isopropyl acrylamide) (pNIPAM for short).

For example, T. Meng, R. Xie et al., Journal of Membrane Science 349 (1-2): 258-267 (2010) “A Thermo-Responsive Affinity Membrane with Nano-Structured Pores and Grafted Poly(N-isopropylacrylamide) Surface Layer for Hydrophobic Adsorption” discloses a modification of shirasu-porous glass (SPG) membranes with an average pore size of 1.8 μm that were modified by plasma-induced grafting-polymerisation. For this, nano-structured pore surfaces were formed by the deposition of silicon oxide nanoparticles on the glass membrane pore surfaces, and pNIPAM clusters were grafted onto the nano-structured pore surface by means of plasma induction. The pore surfaces of the membrane were very hydrophilic at temperatures below 20° C., and very hydrophobic above 40° C.

According to P. F. Li, R. Xie et al., Journal of Membrane Science 337 (1-2): 310-317 (2009), “Thermo-responsive Gating Membranes with Controllable Length and Density of Poly(N-isopropylacrylamide) Chains Grafted by ATRP Method”, pNIPAM was placed on modified anodic aluminum oxide membranes (AAO) by means of ATRP (atom-transfer radical polarization). The membrane produced in this manner manifests a strong temperature dependency between 25° C. and 40° C. in regard to the diffusive permeation of Vitamin B12.

In Macromolecules 40 (16): 5827-5834 (2007): “Phase Behavior and Temperature-Responsive Molecular Filters Based on Self-Assembly of Polystyrene-block-poly(N-isopropylacrylamide)-block-polystyrene”, A. Nykänen, M. Nuopponen et al. report the production of PS-pNIPAM-PS-triblocks which were subsequently applied on polyacrylonitrile membranes by means of spin coating. The grafted membranes manifest significant temperature-dependent switching behavior in which the pores close at temperatures above 32° C.

Finally according to G.-Q. Zhai, L. Ying et al., Surface and Interface Analysis 36 (8): 1048-1051 (2004) “Surface and Interface Characterization of Smart Membranes”, a solution was first produced wherein pNIPAM was mixed with PVDF-g-PAAC and PVDF-g-P4VP solutions, and then phase inversion membranes were produced. The pore size of the membrane produced in this manner increases as the temperature rises and the pH of the aqueous casting solution falls. The flow through the membrane was also temperature and pH-dependent.

The aforementioned production methods are sometimes complex and lengthy and yield membranes that, although thermoresponsive, are not very practical.

### SUMMARY

The object of the invention is contrastingly to present an alternative method for producing thermoresponsive filtration membranes, particularly microfiltration membranes or ultrafiltration membranes, as well as corresponding filtration membranes which possess significant thermoresponsivity and practicality, the method being fast and reliable.

This object is achieved by a method for producing a thermoresponsive filtration membrane, in particular a microfiltration membrane or ultrafiltration membrane, by means of the following method steps:

a) a filtration membrane is wetted or coated with a dopamine solution,

b) the dopamine of the dopamine solution is polymerized in order to produce a polydopamine layer, and

c) the polydopamine-coated filtration membrane is immersed into a coating solution with an end-functionalized poly(N-isopropylacrylamide), and the poly(N-isopropylacrylamide) is bound to the polydopamine layer.

The invention involves the basic concept of not directly modifying an existing membrane such as a ceramic, metallic or polymeric membrane or a membrane based on a glass substrate with pNIPAM, but rather first providing a polydopamine coating. For this, dopamine is present first in an unpolymerized form in a dopamine solution in which the filtration membrane is immersed, or with which the filtration membrane is wetted, and the polydopamine layer is then produced by polymerizing the dopamine of the layer on the filtration membrane. The polydopamine layer adheres extremely well to different surfaces and hence to a large number of membranes such that a stable coating is obtained which remains stable under a variety of conditions of use. According to the invention, this polydopamine layer is modified with pNIPAM, and the membrane thereby becomes thermoresponsive. The membrane itself underneath the dopamine layer is not, or is only insignificantly, modified by pNIPAM. The polydopamine layer accordingly acts as a functionalization promoter for the membrane.

Coating with a polydopamine layer has the additional advantage that the polydopamine layer is highly effective against fouling. The polydopamine-coated membrane is much less susceptible to the pores becoming blocked from contents from the solutions to be filtered than the non-polydopamine-coated membrane.

The procedure of first polymerizing the dopamine in the dopamine coating and only then functionalizing or respectively modifying with pNIPAM has the additional advantage over directly modifying the dopamine that polymerizing and hence surface-coating the membrane is concluded, and the membrane under the polydopamine coating is hence completely protected.

Furthermore, functionalization occurs on the surface of the polydopamine layer which causes the pNIPAM to manifest its (maximum) thermoresponsive effect. Herein, the pNIPAM is bound to the dopamine, and the dopamine is in particular polymerized beforehand, for example at a pH of 8.5 at room temperature.

Another advantage of the method according to the invention is that with membranes that already have different responsivities in an unmodified state, e.g. are pH-responsive, the responsivity is retained even after modification, i.e., after coating with dopamine, polymerization of the dopamine layer and functionalization with pNIPAM. Such membranes as disclosed for example in DE 10 2006 045 282 by the applicant based on PS-b-P4VP and possessing pH responsivity retain said pH-responsivity even after modification according to the invention.

The end-functionalized poly(N-isopropylacrylamide) is preferably amine-terminated. Terminating pNIPAM with an amine on its end yields a particularly reliable and easy modification of the polydopamine layer since it creates bonds with amine groups in a particularly easy and reliable manner.

The structural formula of a possible amine-terminated pNIPAM is as follows:

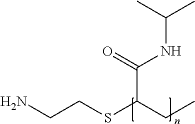

wherein n indicates the number of repeating monomer units.

Preferably, the poly(N-isopropylacrylamide) has an average molecular weight Mₙ of approximately 1,000 to 10,000, in particular between 2,000 and 4,000, and in particular approximately 2,500. This size of the pNIPAM is particularly suitable for the size of the pores of ultrafiltration membranes and nanofiltration membranes having a diameter between 10 nm and 1 μm, and preferably less than 100 nm.

With the aforementioned structural formula, the number of monomer units is approximately 8 to 90 given an average molecular weight between 1,000 and 10,000.

In method step a), the filtration membrane is preferably immersed in a dopamine solution consisting of dopamine hydrochloride in particular dissolved in Tris buffer, preferably at room temperature, in particular, for a duration of 30 to 120 minutes, in particular 45 to 75 minutes.

Preferably, the filtration membrane is washed and/or dried in method step b), in particular at a temperature between 50° C. and 70° C., preferably for at least 30 minutes, and preferably between 45 minutes and 180 minutes. For example, the filtration membrane is dried for 60 minutes at 60° C.

In method step c), the filtration membrane is preferably immersed in a functionalization solution consisting of pNIPAM-NH₂, preferably dissolved in Tris buffer.

Tris buffer is a slightly basic organic compound possessing a favourable buffering effect. The primary component is tris(hydroxymethyl)aminomethane. It possesses a favourable buffering capacity within a pH range between 7.2 and 9.0.

In method step c), the filtration membrane is preferably shaken in the solution for a duration of 2 to 4 hours at a temperature of 50° C. to 70° C. and then for a duration of more than 6 hours between 18° C. and 25° C. Optimum modification of the filtration membrane or respectively polydopamine layer results in these conditions.

The filtration membrane is preferably washed and/or dried after method step c).

The dopamine solution and coating solution advantageously do not possess any solvent for the filtration membrane. The underlying membrane is therefore not damaged during modification.

Preferably, the employed filtration membrane is an isoporous and/or integral asymmetric, block copolymer membrane, in particular based on a PS-b-P4VP, a PS-b-P2VP or a PS-b-PEO block copolymer. These membranes have an integral asymmetrical structure in which a separation-active layer with an isoporous microphase-separated structure transitions seamlessly into a foam-like structure of a solvent-induced phase transition. These are particularly advantageously coated with the polydopamine layer, already possess pH responsivity, and are rendered more thermoresponsive by modification with pNIPAM. The invention is however not restricted thereto but is rather applicable to all types of filtration membranes that can be coated with polydopamine.

The underlying object of the invention is also achieved by a thermoresponsive filtration membrane, in particular a microfiltration membrane or ultrafiltration membrane, that is produced or producible by the above-described method according to the invention having a polydopamine coating that is functionalized with pNIPAM. This thermoresponsive filtration membrane has the above-described properties, features and advantages.

Preferably, pores of the filtration membrane open above approximately 20° C., in particular above approximately 25° C. The temperature at which the transition occurs from closed to open pores caused by the expansion of the clusters of pNIPAM chains depends, inter alia, on the concentration of the solution.

The pores of the filtration membrane preferably have a diameter between 10 nm and 500 nm, in particular up to 100 nm. This refers to the unclosed state of the pores.

The thermoresponsive filtration membrane can be a flat membrane or hollow fiber membrane.

The filtration membrane is preferably also pH-responsive, the pores closing at a low pH, in particular below approximately 3.8 to 3.4. The pH threshold depends on the type of membrane.

In a preferred embodiment of the thermoresponsive filtration membrane according to the invention, the filtration membrane is a polymer membrane, in particular an isoporous and/or integral asymmetric block copolymer membrane, especially based on a PS-b-P4VP, PS-b-P2VP or a PS-b-PEO block copolymer.

Further features of the invention will become apparent from the description of embodiments according to the invention together with the claims and the included figures. Embodiments according to the invention can fulfil individual characteristics or a combination of several characteristics.

### BRIEF DESCRIPTION OF THE DRAWINGS

The invention is described below, without restricting the general intent of the invention, based on exemplary embodiments in reference to the figures, whereby we expressly refer to the figures with regard to the disclosure of all details according to the invention that are not explained in greater detail in the text. In the figures:

FIG. 1 shows signals of chemical shifts of a polydopamine-coated a) membrane with and without functionalization with pNIPAM b).

FIG. 2 shows the IR spectra of uncoated (a), coated (b) and functionalized membranes (c).

FIG. 3 shows the temperature dependence of the water flow of an uncoated, coated and modified membrane.

FIG. 4 shows the pH-dependence of the water flow of a modified membrane at different temperatures.

FIG. 5 at a) and b) shows raster electron microscopic images of a surface and a transverse fracture of an uncoated membrane.

FIG. 6 at a) and b) shows raster electron microscopic images of a surface a a transverse fracture of a coated and modified membrane.

### DETAILED DESCRIPTION

In the following, the invention will be explained with reference to an example of a flat membrane based on the block copolymer polystyrene-block-poly-4-vinylpyridine (PS-b-P4VP).

The block copolymer membranes were produced according to the instructions of the method disclosed in the applicant's German patent No. 10 2006 045 282 and have an isoporous, microphase-separated, separation-active surface layer that changes transition-free and directly into a typical solvent-induced phase-separated sponge-like structure.

The block copolymer membranes (approximately 4 cm×4 cm) were immersed in a reaction solution consisting of 2 mg/ml dopamine hydrochloride, dissolved in 15 mM Tris buffer (tris(hydroxymethyl)aminomethane, pH 8.5-8.8, ultrapure water) and shaken in a shaker for 60 minutes at room temperature in an open vessel. The membranes were then washed three times for 30 minutes with ultrapure water and dried at 60° C.

pNIPAM-NH₂ by Sigma Aldrich with an average molecular weight Mₙ of 2,500 (product No. 724823) was used for modification.

The membranes were characterized in the different phases of before coating, after coating and after modification by means of NMR (nuclear magnetic resonance), IR (infrared spectrometry), water flow measurement and REM (raster electron microscopy).

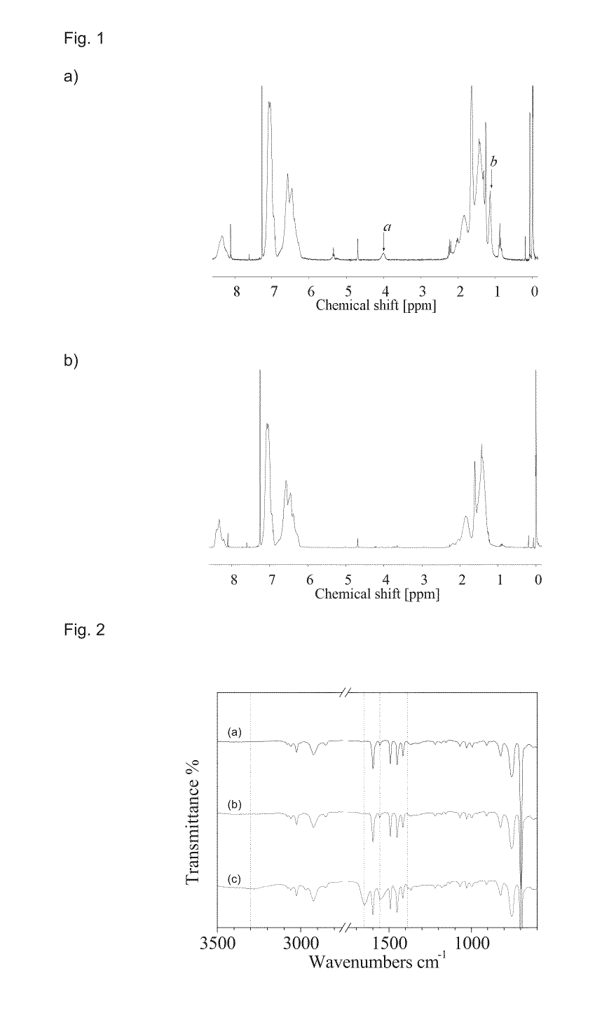

FIG. 1 shows the signals of the chemical shift in NMR, wherein a) shows the chemical shift of the polydopamine-coated and pNIPAM-modified membrane, whereas b) shows the chemical shift of the unmodified polydopamine-coated membrane for comparison. Letters a and b in a) indicate signals at the chemical shifts of 4.0 and 1.1 ppm that are ascribable to the isopropyl group of pNIPAM. These do not exist in b).

FIG. 2 shows IR spectra of the (a) PS-b-P4VP membrane, (b) the PS-b-P4VP membrane coated with polydopamine, and (c) the PS-b-P4VP coated with polydopamine after reacting with pNIPAM-NH₂.

There are no significant differences between the IR spectra of the PS-b-P4VP membrane before and after polydopamine coating (see (a) and (b)). After further reaction with pNIPAM-NH₂ (see (c)), the IR spectrum manifests characteristic peaks of secondary amides: The C═O stretching vibration and N—H in-plane deformation vibration at 1650 and 1550 cm⁻¹. The wide signal at 3600-3200 cm-¹ is ascribable to the N—H stretching vibration of secondary amides. The two small peaks at 1369 and 1388 cm⁻¹ are ascribable to the deformation vibrations of the isopropyl group of the pNIPAM backbone structure.

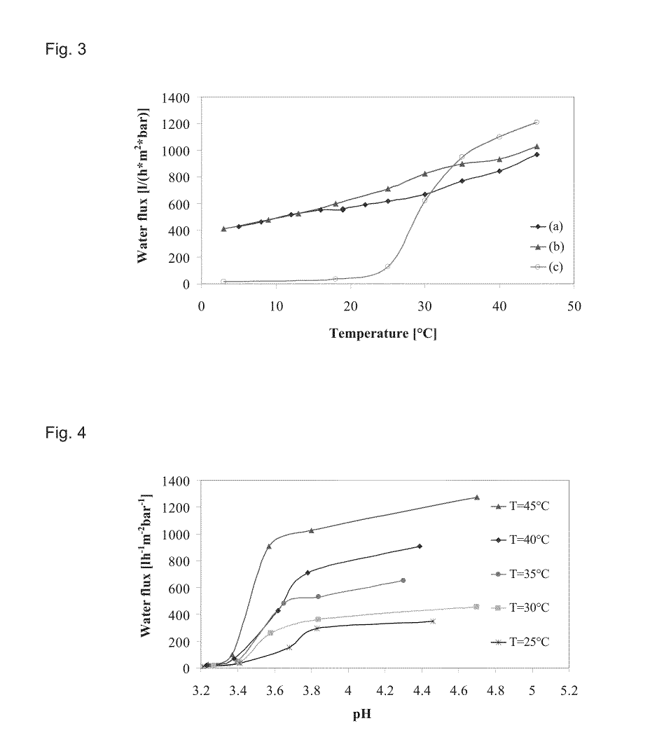

FIG. 3 and FIG. 4 show water flow measurements with reference to the membrane according to the invention, and its precursors. The pNIPAM-modified membrane is accordingly thermoresponsive and pH-responsive.

For this purpose, different water flow measurements were performed in a dead-end system at approximately 2.1 bar between 3° C. and 45° C. The results are shown in FIG. 3. The water flow increases with the temperature in an approximately linear manner for the uncoated membrane (a) and the polydopamine-coated yet unmodified membrane (b). With the membrane modified with pNIPAM (c), the water flow rises very sharply around the so-called “lower critical solution temperature (LCST)” of pNIPAM at approximately 25° C. The pores are nearly closed below 25° C. Typically, pNIPAM has an LCST at approximately 30° C. to 32° C.

FIG. 4 shows that the membrane modified with pNIPAM is still pH-responsive—a characteristic that the PS-b-P4VP membranes possess. For this purpose, water flows were measured with reference to the pH at five different temperatures between 25° C. and 45° C.

According to FIG. 4, the water flow decreases at a pH between 3.8 and 3.4 at all temperatures, which indicates that the membrane is still pH-responsive.

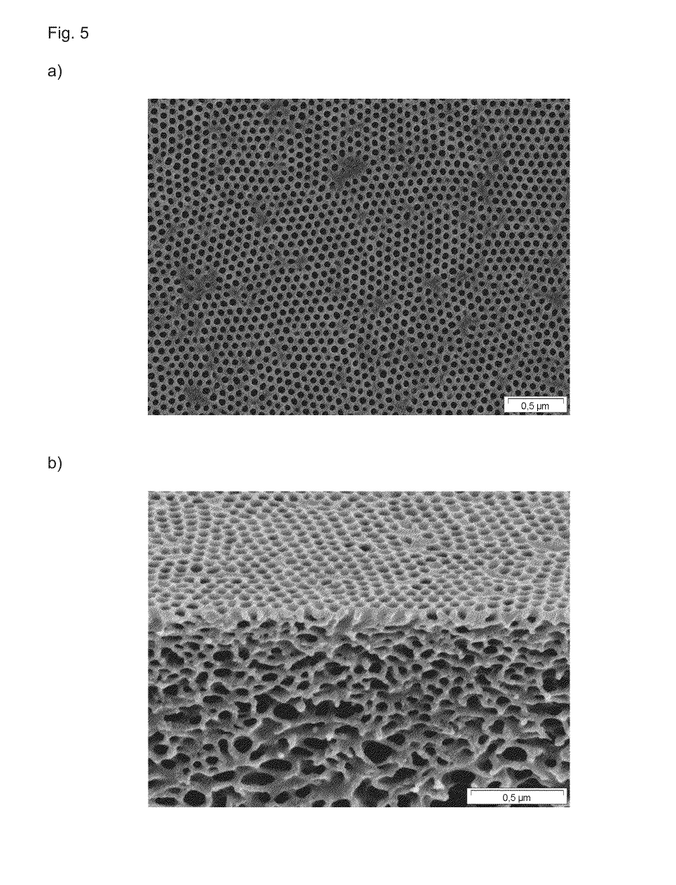

FIG. 5 at a), b) shows REM images of the surface and a transverse fracture of a PS-b-P4VP membrane before being modified with pNIPAM. The typical integral asymmetric structure is depicted in which the separation-active surface has a regular, isoporous microphase-separated structure that arises from the self-organization of the block copolymers upon evaporation of part of the solvent close to the surface, wherein this regular structure transitions into a typical sponge-like structure of the solvent-induced phase inversion.

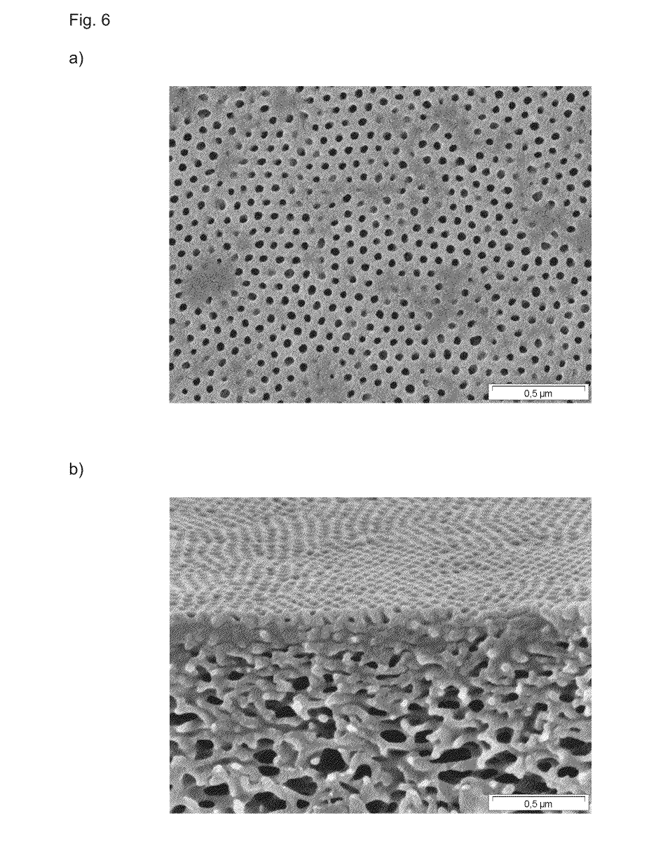

In comparison, FIG. 6 at a), b) depicts an REM image of the surface or respectively transverse fracture of a corresponding membrane after modification with pNIPAM. The structure of the pores of the separation-active surface layer as well as the sponge-like structure in the bulk is retained, wherein the diameter of the pores has decreased from the coating and modification.

All named features, including those to be taken from the figures alone, and individual features which are disclosed in combination with other features, are considered individually and in combination as belonging to the invention. Embodiments according to the invention can be realized by individual features, or a combination of several features.

1. A method for producing a thermoresponsive filtration membrane, in particular a microfiltration membrane or ultrafiltration membrane, comprising the following steps:
a) a filtration membrane is wetted or coated with a dopamine solution,
b) the dopamine of the dopamine solution is polymerized in order to produce a polydopamine layer, and
c) the polydopamine-coated filtration membrane is immersed into a coating solution with an end-functionalized poly(N-isopropylacrylamide), and the poly(N-isopropylacrylamide) is bound to the polydopamine layer.

2. The method according to claim 1, wherein the end-functionalized poly(N-isopropylacrylamide) is amine-terminated.

3. The method according to claim 1, wherein the poly(N-isopropylacrylamide) has an average molecular weight Mₙ of approximately 1,000 to 10,000, in particular between 2,000 and 4,000, in particular approximately 2,500.

4. The method according to claim 1, wherein in step a), the filtration membrane is immersed in a dopamine solution consisting of dopamine hydrochloride, dissolved in Tris buffer, at room temperature, for a duration of 30 to 120 minutes, in particular 45 to 75 minutes.

5. The method according to claim 1, wherein the filtration membrane is washed and/or dried in method step b), at a temperature between 50° C. and 70° C., for at least 30 minutes, and between 45 minutes and 180 minutes.

6. The method according to claim 1, wherein in step c), the filtration membrane is immersed in a functionalization solution consisting of pNIPAM-NH₂, dissolved in Tris buffer.

7. The method according to claim 6, wherein the filtration membrane is first shaken in the solution for a duration of 2 to 4 hours at a temperature of 50° C. to 70° C. and then for a duration of more than 6 hours between 18° C. and 25° C.

8. The method according to claim 1, wherein the filtration membrane is washed and/or dried after method step c).

9. The method according to claim 1, wherein the dopamine solution and the coating solution do not possess any solvent for the filtration membrane.

10. The method according to claim 1, wherein the employed filtration membrane is an isoporous and/or integral asymmetric, block copolymer membrane, based on a PS-b-P4VP, a PS-b-P2VP or a PS-b-PEO block copolymer.

11. A thermoresponsive filtration membrane, in particular a microfiltration membrane or ultrafiltration membrane, produced or producible according to a method according to claim 1, having a polydopamine coating that is functionalized with pNIPAM.

12. The thermoresponsive filtration membrane according to claim 11, wherein pores of the filtration membrane open above approximately 20° C., and above approximately 25° C.

13. The thermoresponsive filtration membrane according to claim 12, wherein the pores of the filtration membrane have a diameter between 10 nm and 500 nm, up to 100 nm.

14. The thermoresponsive filtration membrane according to claim 13, wherein the filtration membrane is also pH-responsive, the pores closing at a low pH, below approximately 3.8 to 3.4.

15. The thermoresponsive filtration membrane according to claim 14, wherein the filtration membrane is an isoporous and/or integral asymmetric, block copolymer membrane, based on a PS-b-P4VP, a PS-b-P2VP or a PS-b-PEO block copolymer.
